(19) United States
(12) Patent Application Publication
(10) Pub. No.: US 2007/0246363 A1
(43) Pub. Date: Oct. 25, 2007

(54) INTEGRATED ELECTROCHEMICAL HYDROGEN COMPRESSION SYSTEMS

(75) Inventors: Glenn A Eisman, Niskayuna, NY (US); Daryl L Ludlow, Rensselaer, NY (US)

Correspondence Address: H2 PUMP, LLC, 11 NORTHWAY LANE NORTH, LATHAM, NY, 12110, US

(73) Assignee: H2 Pump LLC, Latham, NY (US)

(21) Appl. No.: 11/737,733

(22) Filed: Apr. 19, 2007

Related U.S. Application Data
(60) Provisional application No. 60/793,415, filed on Apr. 20, 2006.

(51) Int. Cl. B01D 59/42; C25B 9/00

(52) U.S. Cl. 204/520; 204/252

(57) ABSTRACT

Apparatus and operating methods are provided for integrated electrochemical hydrogen compression systems. In one possible embodiment, an electrochemical hydrogen pumping cell is energized to generate a hydrogen output from a hydrogen source that can be pure hydrogen or a mixed gas containing hydrogen. The hydrogen output is fed to a compressor, and the compressor is energized to provide a compressed hydrogen output to a hydrogen load. In some embodiments, the compressor is configured to feed hydrogen to the cell, which in turn feeds the load. Various methods, features and system configurations are discussed.

### CROSS REFERENCE TO RELATED APPLICATIONS

This application claims priority under 35 USC 119(e) from U.S. Provisional Application No. 60/793,415, filed Apr. 20, 2006, naming Ludlow and Eisman as inventors, and titled “MULTI-STAGE ELECROCHEMICAL H2 PUMP.” This application is hereby incorporated herein by reference in their entirety and for all purposes.

### TECHNICAL FIELD OF THE INVENTION

The present invention relates to apparatus and operating methods for integrated electrochemical hydrogen compression systems. Various methods, features and system configurations are discussed.

### BACKGROUND

Electrochemical technologies are of increasing interest, due in part to advantages provided in efficiency and environmental impact over traditional mechanical and combustion based technologies.

A variety of electrochemical fuel cell technologies are known, wherein electrical power is produced by reacting a fuel such as hydrogen in an electrochemical cell to produce a flow of electrons across the cell, thus providing an electrical current. For example, in fuel cells utilizing proton exchange membrane technology, an electrically non-conducting proton exchange membrane is typically sandwiched between two catalyzed electrodes. One of the electrodes, typically referred to as the anode, is contacted with hydrogen. The catalyst at the anode serves to divide the hydrogen molecules into their respective protons and electrons. Each hydrogen molecule produces two protons which pass through the membrane to the other electrode, typically referred to as the cathode. The protons at the cathode react with oxygen to form water, and the residual electrons at the anode travel through an electrically conductive path around the membrane to produce an electrical current from anode to cathode. The technology is closely analogous to conventional battery technology.

Electrochemical cells can also be used to selectively transfer (or “pump”) hydrogen from one side of the cell to another. For example, in a cell utilizing a proton exchange membrane, the membrane is sandwiched between a first electrode (anode) and a second electrode (cathode), a gas containing hydrogen is placed at the first electrode, and an electric potential is placed between the first and second electrodes, the potential at the first electrode with respect to ground (or “zero”) being greater than the potential at the second electrode with respect to ground. Each hydrogen molecule reacted at the first electrode produces two protons which pass through the membrane to the second electrode of the cell, where they are rejoined by two electrons to form a hydrogen molecule (sometimes referred to as “evolving hydrogen” at the electrode).

Electrochemical cells used in this manner are sometimes referred to as hydrogen pumps. In addition to providing controlled transfer of hydrogen across the cell, hydrogen pumps can also by used to separate hydrogen from gas mixtures containing other components. Where the hydrogen is pumped into a confined space, such cells can be used to compress the hydrogen, at very high pressures in some cases.

There is a continuing need for apparatus, methods and applications relating to electrochemical cells.

### SUMMARY OF THE INVENTION

Apparatus and operating methods are provided for integrated electrochemical hydrogen compression systems. In one possible embodiment, an electrochemical hydrogen pumping cell is energized to generate a hydrogen output from a hydrogen source that can be pure hydrogen or a mixed gas containing hydrogen. The hydrogen output is fed to a compressor, and the compressor is energized to provide a compressed hydrogen output to a hydrogen load. In some embodiments, the compressor is configured to feed hydrogen to the cell, which in turn feeds the load. Numerous optional features and system configurations are provided.

Various aspects and features of the invention will be apparent from the following Detailed Description and from the Claims.

### DESCRIPTION OF DRAWINGS

FIG. 1 is a schematic diagram illustrating one possible embodiment of an integrated electrochemical hydrogen compression system.

FIG. 2 is a schematic diagram illustrating one possible embodiment of an integrated electrochemical hydrogen compression system.

FIG. 3 is a schematic diagram illustrating one possible embodiment of an integrated electrochemical hydrogen compression system.

FIG. 4 is a schematic diagram illustrating one possible embodiment of an integrated electrochemical hydrogen compression system.

### DETAILED DESCRIPTION OF THE INVENTION

It will be appreciated that the apparatus, methods, and applications of the invention can include any of the features described herein, either alone or in combination.

The Figures are referenced in the following discussion to provide an illustration of how various features can be configured within an integrated system. It should be noted that the invention is not limited to the illustrative configurations shown in the Figures. Also, it will be appreciated that the Figures only illustrate a limited number of the inventive features discussed herein.

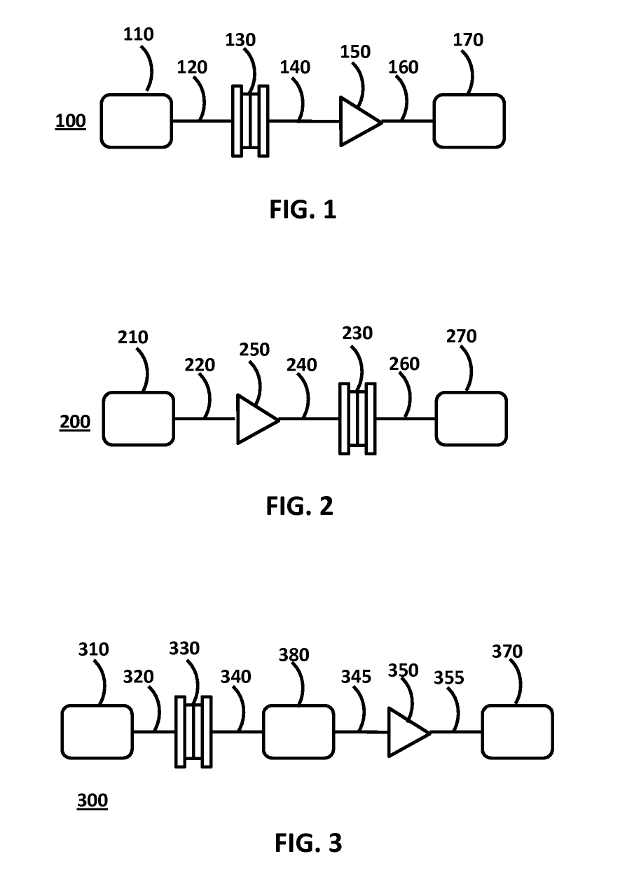

In FIG. 1, an integrated electrochemical hydrogen compression system 100 is provided. The system draws a hydrogen source gas from a source vessel 110 and pumps the hydrogen through conduit 120 to an electrochemical cell 130, where the hydrogen is separated and exhausted via conduit 140 and fed to a compressor 150. The compressor 150 compresses the hydrogen and flows it to a hydrogen load 170 via conduit 160. In this context, “source vessel” refers to any conduit of hydrogen gas, such as a storage container, pressure vessel, pipeline, etc. Such a pipeline could be any source or flow of hydrogen gas or hydrogen-containing gas that can feed hydrogen to the cell 130. “Hydrogen source gas” refers to any gas containing hydrogen, whether the gas is pure hydrogen, or hydrogen is merely a dilute component of the gas, etc. The hydrogen source gas can be variously referred to as hydrogen gas, inlet hydrogen, etc. Unless otherwise indicated, the hydrogen source gas can be at any temperature or relative humidity. “Hydrogen load” refers to a storage tank, exhaust tank, pipeline, or any application configured to accept the flow of hydrogen from the cell 130.

In the context of this invention, “compressor” means any type of mechanical compressor. Diaphragm compressors are often used in hydrogen applications such as with systems under the present invention, but the invention is not limited to the type of compressor that is used. Any compressor can be used that is capable of compressing hydrogen.

Suitable electrochemical hydrogen pumping cell technologies are well known, such as described in the teachings of U.S. Pat. Nos. 4,620,914; 6,280,865; 7,132,182 and published U.S. patent application Ser. Nos. 10/478,852 and 11/696,179. In certain embodiments, the proton exchange membranes used under the present invention can include those based on PBI materials. Where such “high temperature” membranes are used, it is generally desirable to maintain them at an operating temperature of at least 100 C, such as 140 C or higher, or 160 C or higher.

Where PBI membranes are used, it is generally desirable to initiate operation with a membrane imbibed with phosphoric acid at a ratio of at least 20 moles phosphoric acid to polybenzimidazole repeating unit, or greater than 32 moles phosphoric acid to polybenzimidazole repeating unit, or even at least 40 moles phosphoric acid to polybenzimidazole repeating unit. It is also generally preferable that PBI materials be those formed from the sol-gel process. One advantage of PBI-based membranes is that they can generally be operated on dry gasses, where membranes such as Nafion® required humidification. In the context of the present invention, reference may be made to dry hydrogen source gas, or hydrogen source gas having less than 5% relative humidity (e.g., at the operating temperature of the cell), which is used to distinguish gasses that may not be completely dry, but are still too dry for use with membranes such as Nafion® that require humidification.

It is also generally preferable to use a proton exchange membrane having a proton conductivity that is as high as possible. For example, membranes preferred under the present invention are generally those having a proton conductivity of at least 0.1 S/cm, including those having a proton conductivity of at least 0.2 S/cm. Other proton exchange membranes can also be used with the present invention, such as Nafion®, PEEK, etc.

FIG. 2 illustrates an alternate configuration 200. The system draws a hydrogen source gas from a vessel 210 and pumps the hydrogen through conduit 220 to a compressor 250. The compressor 250 compresses the hydrogen and supplies it via conduit 240 to an electrochemical cell 230, where the hydrogen is separated and exhausted via conduit 260 to a hydrogen load 270.

FIG. 3 illustrates an alternate configuration 300. The system draws a hydrogen source gas from a vessel 310 and pumps the hydrogen through conduit 320 to an electrochemical cell 330, where the hydrogen is separated and exhausted via conduit 340 and fed to a reservoir vessel 380. In this context, “reservoir vessel” refers to a vessel configured to receive hydrogen flow from the cell 330. As an example, the reservoir vessel 380 can be a storage tank that can be pressurized to buffer flow from the cell 380 to the rest of the system 300, for example through a pressure regulator valve. The hydrogen is flowed from vessel 380 via conduit 345 to a compressor 350. The compressor 350 compresses the hydrogen and flows it to a hydrogen load 370 via conduit 355.

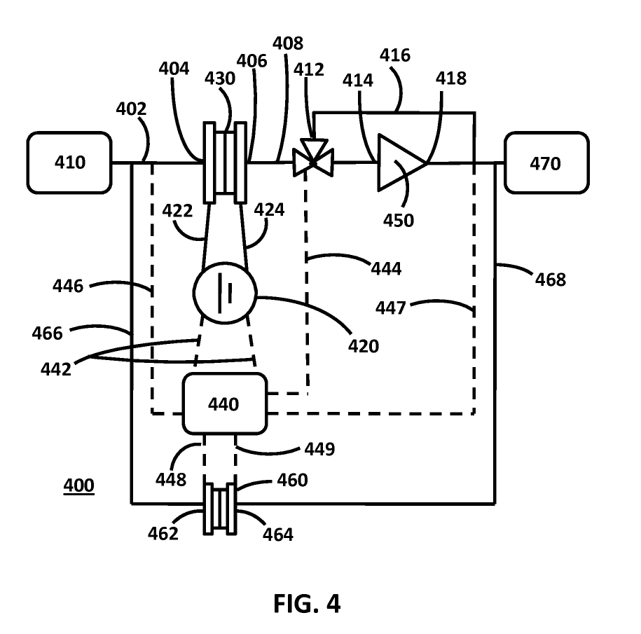

FIG. 4 illustrates an alternate configuration 400. The system draws a hydrogen source gas from a vessel 410 and pumps the hydrogen through conduit 402 to an electrochemical cell 430, where the hydrogen is separated and exhausted via conduit 408. The hydrogen is flowed through a valve 412 that directs flow under low pressure operation (such regime being user-selectively defined) through bypass conduit 416 to hydrogen load 470.

When the cell 430 outlet pressure reaches a desired level, the valve 412 closes bypass conduit 416 and directs hydrogen flow to an inlet 414 of a compressor 450. The compressor outlet 418 feeds the hydrogen load 470. In this way, the pumping cell 430 can be used for lower pressure duty, and the compressor 450 is used to provide added stage compression for higher pressure duty. In other possible embodiments, the position of the cell 430 and compressor 450 can be exchanged in the system such that the compressor 450 can be used for lower pressure duty, and the cell 430 can be used to provide added stage compression for higher pressure duty. In yet other embodiments, a bypass circuit such as conduit 416 and valve 412 can be configured to bypass the cell 430 to allow direct flow from vessel 410 to the compressor 450, or in some cases the cell 430 and compressor 450 can both be bypassed for direct hydrogen supply to load 470 from vessel 410.

The cell 430 is connected to a power supply 420 by leads 422 and 424 that correspond to the anode 404 and cathode 406 of the cell 430.

Generally the power supply 420 is configured with a voltage limit and a current limit, which are output thresholds over which the power supply 420 will not exceed. In general, increases in output current from the power supply 420 will result in increases in hydrogen flow across the cell 430 (i.e., ionized at the anode and evolved at the cathode). Where the outlet hydrogen flow from the cell 430 is restricted, as potentially with valve 412, for example, the outlet hydrogen can be pressurized. In general, an increase in the electrical potential provided across the cell 430 by the power supply 420 will result in an increased capacity for developing a pressure differential across the cell 430, depending on the degree to which the cell cathode outlet hydrogen flow is restricted (e.g., through conduit 408).

A controller 440 is connected to the power supply via signal leads 442. The controller 440 is also adapted to measure a pressure of the cell anode 404 via connection 466 to conduit 402. The controller 440 is also adapted to measure a pressure of the hydrogen load 470 via connection 447 to the outlet 418 of the compressor 450. The controller 440 is also adapted to control the valve 412 via signal conduit 444.

As an alternative to control over the system 400 based on pressure measurements from signal conduits 444 and 446, the embodiment shown in FIG. 4 provides a reference cell 460 to regulate a pressure of hydrogen at the hydrogen load 470. The reference cell 460 is an electrochemical cell similar to the pumping cell 430, but can be any type of electrochemical cell. The reference cell has a first electrode 462 and a second electrode 464. The reference cell first electrode 462 is in fluid communication with the hydrogen source gas via conduit 466, which has the effect of keeping the reference cell first electrode 462 at about the same pressure as the pumping cell anode plenum 404. In this context, “plenum” refers to the conduits or spaces through which gasses flow across the electrodes. The electrode plenums are sometimes referred to synonymously with the electrodes themselves. “Fluid communication” is used to indicate that the system is capable of providing gas flow in any manner from the vessel to the electrode. The reference cell second electrode 464 is in fluid communication with the hydrogen load 470 via conduit 468, which has the effect of keeping the reference cell second electrode 464 at about the same pressure as the hydrogen load 470.

The reference cell 460 is connected to the controller 440 (or optionally power supply 420) via voltage sensing leads 448 and 449. The potential across leads 448 and 449 can be used to infer the hydrogen pressure at the hydrogen load 470, or the pressure differential between the load 470 and the supply vessel 410. In some cases, for example where it is desirable to maintain a constant hydrogen pressure at the hydrogen load 470, such a configuration can provide an advantage over measurements of pumping cell 430 outlet pressure taken at the pumping cell cathode plenum 406, because there may be a lag before pressure increases reach the hydrogen load 470. The reference cell 460 can also be configured in fluid communication with any other part of the system. The system can thus be configured to vary the electrical potential applied to the electrochemical cell 430 in response to the electrical potential of the reference cell 460.

The invention also provides methods for operation of integrated electrochemical hydrogen compression systems. As an example, in one embodiment, a method is provided comprising the following steps: energizing an electrochemical hydrogen pumping cell to generate a hydrogen output; flowing the hydrogen output to a hydrogen load; measuring a pressure of a hydrogen gas in the system; energizing a compressor when the pressure of the hydrogen gas reaches a predetermined threshold; flowing the hydrogen output to an inlet of the compressor; and flowing hydrogen from the compressor to the hydrogen load. As examples, the “hydrogen gas in the system” can be the pressure of the hydrogen output from the pumping cell, the pressure of the hydrogen load, etc.

Any of the methods described herein can also further include the step of modulating an electrical potential across the electrochemical hydrogen pumping cell to control a pressure of the hydrogen output. In some cases, the pressure can be held constant, for example to supply hydrogen at a constant pressure to a compressor. In some embodiments, methods can further include the step of modulating an electrical current fed through the electrochemical hydrogen pumping cell to control a flow rate of the hydrogen output.

Any of the methods described herein can also include the use of a reference cell as previously discussed to monitor and control system performance. For example, methods may include measuring an electrical potential of a reference cell, wherein the reference cell has a first reference electrode and a second reference electrode, wherein the first reference electrode is in fluid communication with the first electrode of the electrochemical cell, and the second reference electrode is in fluid communication with the second electrode of the electrochemical cell. Such methods may further include varying the electrical potential applied to the electrochemical cell in response to the electrical potential measured from the reference cell. It will be appreciated that the reference cell can be in fluid communication with any part of the hydrogen flow within the system. For example, the second reference electrode can be in fluid communication with a hydrogen reservoir adapted to receive hydrogen from the second electrode of the electrochemical cell.

In another embodiment, a method is provided comprising the following steps: energizing an electrochemical hydrogen pumping cell to flow hydrogen into a vessel; energizing a compressor when a predetermined vessel pressure is reached; and flowing hydrogen from the vessel to an inlet of the compressor at a constant pressure.

In another embodiment, a method is provided comprising the following steps: energizing an electrochemical hydrogen pumping cell to generate a hydrogen output; modulating an electrical potential across the electrochemical hydrogen pumping cell to control an outlet pressure of the hydrogen output; flowing the hydrogen output to an inlet of a compressor; energizing the compressor to compress the hydrogen output; and flowing hydrogen from the compressor to a hydrogen load.

In another embodiment, a method is provided comprising the following steps: energizing an electrochemical hydrogen pumping cell to flow hydrogen to an inlet of a compressor; energizing the compressor to flow hydrogen to a hydrogen load; wherein the compressor has a ratio of (electrical power consumed by the compressor) to (hydrogen flowed to the hydrogen load); and increasing an electrical potential supplied across the electrochemical hydrogen pumping cell when the ratio falls below a predetermined threshold. As an example, the efficiency of the compressor may begin to fall as the compressor begins to reach performance limitations as to output flow or pressure differential across the compressor, and so the ratio above may increase as more power is needed to drive hydrogen flow. The system can compensate by increasing the power supplied to the compressor, or as another example by increasing the outlet pressure of a pumping cell supplying the compressor so that the pressure differential across the compressor is effectively lowered for a given compressor outlet pressure, since the compressor is then being used in a more limited role for stage compression in coordination with the cell.

In some embodiments, the pressure differential across the compressor can be maintained constant, or within a predetermined range, for example, operating the compressor within a desired regime of high efficiency. The outlet pressure of the compressor can be varied by adjusting the outlet pressure of a pumping cell feeding the compressor. Similarly, in some embodiments, the outlet pressure of the cell can be maintained constant, or within a predetermined range. The outlet pressure of the cell can be varied by adjusting the outlet pressure of a compressor feeding the cell.

In another embodiment, a method is provided comprising the following steps: energizing an electrochemical hydrogen pumping cell to generate a hydrogen output; flowing the hydrogen output to a hydrogen load; measuring a pressure of the hydrogen output; energizing a compressor when the pressure of the hydrogen output reaches a predetermined threshold; and flowing hydrogen from the compressor to an inlet of the electrochemical hydrogen pumping cell.

In another embodiment, a method is provided comprising the following steps: energizing a compressor to supply output hydrogen to a hydrogen load; measuring a pressure of the output hydrogen; energizing an electrochemical hydrogen pumping cell when the pressure reaches a predetermined threshold; flowing the output hydrogen to an inlet of the electrochemical hydrogen pumping cell; exhausting hydrogen from the electrochemical hydrogen pumping cell to the hydrogen load at an elevated pressure.

In another embodiment, a method is provided comprising the following steps: energizing an electrochemical hydrogen pumping cell to supply hydrogen to a compressor; energizing the compressor to supply hydrogen to a hydrogen load; maintaining a differential pressure across the compressor within a predetermined range; and varying an outlet pressure of the electrochemical hydrogen pumping cell to vary an outlet pressure of the compressor.

In a similar embodiment, a method is provided comprising the following steps: energizing a compressor to supply hydrogen to an electrochemical hydrogen pumping cell; energizing the electrochemical hydrogen pumping cell to supply hydrogen to a hydrogen load; maintaining a differential pressure across the compressor within a predetermined range; and varying an outlet pressure of the electrochemical hydrogen pumping cell. As discussed above, in some embodiments, the differential pressure across the compressor can be held constant.

As discussed above, in such embodiments, the differential pressure across the compressor can be held constant, for example by modulating an electrical potential across the electrochemical hydrogen pumping cell to control a pressure of the hydrogen supplied to the compressor.

The invention also provides various integrated electrochemical hydrogen compression systems. For example, a system can include an electrochemical hydrogen pumping cell and a compressor; wherein the electrochemical hydrogen pumping cell has an inlet in fluid communication with a hydrogen source; and wherein the electrochemical hydrogen pumping cell has an outlet in fluid communication with a compressor inlet of the compressor; and wherein the compressor has a compressor outlet in fluid communication with a hydrogen load.

In some embodiments, systems can include a valve adapted to regulate hydrogen flow between the electrochemical hydrogen pumping cell and the compressor. The valve can be any type of valve such as manual or automatic, a check valve, an isolation valve, a 3-way bypass valve, etc.

In some embodiments, particularly those using high temperature proton exchange membranes in the pumping cell, it may be desirable to maintain an elevated cell temperature suitable for the operating temperature of the membrane, e.g., over 100 C, such as 140 C or higher, or 160 C or higher. Thus, a heater may be provided to heat the hydrogen fed to the cell, or the cell itself.

In some embodiments, systems can include a bypass line from the electrochemical hydrogen pumping cell outlet to the compressor outlet, and a controller adapted to measure a pressure of the compressor outlet; wherein the controller is adapted to supply the hydrogen load via the bypass line when the compressor outlet pressure is below a predetermined threshold; and wherein the controller is adapted to close the bypass line when the compressor outlet pressure is above a predetermined threshold.

In another embodiment, a system is provided that includes a compressor and an electrochemical hydrogen pumping cell; wherein the compressor has a compressor inlet in fluid communication with a hydrogen source; wherein the compressor has a compressor outlet in fluid communication with an inlet of the electrochemical hydrogen pumping cell; and wherein the electrochemical hydrogen pumping cell has an outlet in fluid communication with a hydrogen load.

Whereas the embodiments and features discussed herein are generally described with respect to individual electrochemical cells, it will be appreciated that they are also applicable to cells grouped in stack configurations. Descriptions and claims as to the configuration and operation of individual cells can thus be taken to cover cells by themselves, or a cell forming part of a stack configuration.

The inventive concepts discussed in the claims build on traditional electrochemical cells technologies that are well known in the art. As examples, various suitable designs and operating methods that can be used as a base to implement the present invention are described in the teachings of U.S. Patent Nos. 4,620,914; 6,280,865; 7,132,182 and published U.S. patent application Ser. Nos. 10/478,852 and 11/696,179, which are each hereby incorporated by reference in their entirety.

While the invention has been shown or described in only some of its forms, it should be apparent to those skilled in the art that it is not so limited, but is susceptible to various changes without departing from the scope of the invention.

We claim:

1. A method of operating an integrated electrochemical hydrogen compression system, comprising:
energizing an electrochemical hydrogen pumping cell to generate a hydrogen output;
flowing the hydrogen output to a hydrogen load;
measuring a pressure of a hydrogen gas in the system;
energizing a compressor when the pressure of the hydrogen gas reaches a predetermined threshold;
flowing the hydrogen output to an inlet of the compressor; and
flowing hydrogen from the compressor to the hydrogen load.

2. The method of claim 1, wherein the pressure of the hydrogen gas is a pressure of the hydrogen output.

3. The method of claim 1, wherein the pressure of the hydrogen gas is a pressure of the hydrogen load.

4. The method of claim 1, further comprising:
modulating an electrical potential across the electrochemical hydrogen pumping cell to control a pressure of the hydrogen output.

5. The method of claim 1, further comprising:
modulating an electrical current fed through the electrochemical hydrogen pumping cell to control a flow rate of the hydrogen output.

6. The method of claim 1, further comprising:
measuring an electrical potential of a reference cell, wherein the reference cell has a first reference electrode and a second reference electrode, wherein the first reference electrode is in fluid communication with a first electrode of the electrochemical hydrogen pumping cell, and the second reference electrode is in fluid communication with a second electrode of the electrochemical hydrogen pumping cell.

7. The method of claim 6, further comprising:
varying an electrical potential applied to the electrochemical hydrogen pumping cell in response to the electrical potential measured from the reference cell.

8. The method of claim 6, wherein:
the second reference electrode is in fluid communication with the hydrogen load.

9. A method of operating an integrated electrochemical hydrogen compression system, comprising:
energizing an electrochemical hydrogen pumping cell to flow hydrogen into a vessel;
energizing a compressor when a predetermined vessel pressure is reached; and
flowing hydrogen from the vessel to an inlet of the compressor at a constant pressure.

10. A method of operating an integrated electrochemical hydrogen compression system, comprising:
energizing an electrochemical hydrogen pumping cell to generate a hydrogen output;
modulating an electrical potential across the electrochemical hydrogen pumping cell to control an outlet pressure of the hydrogen output;
flowing the hydrogen output to an inlet of a compressor;
energizing the compressor to compress the hydrogen output; and
flowing hydrogen from the compressor to a hydrogen load.

11. The method of claim 10, further comprising:
modulating an electrical current fed through the electrochemical hydrogen pumping cell to control a flow rate of the hydrogen output.

12. The method of claim 10, further comprising:
measuring an electrical potential of a reference cell, wherein the reference cell has a first reference electrode and a second reference electrode, wherein the first reference electrode is in fluid communication with a first electrode of the electrochemical hydrogen pumping cell, and the second reference electrode is in fluid communication with a second electrode of the electrochemical hydrogen pumping cell.

13. The method of claim 12, further comprising:
varying an electrical potential applied to the electrochemical hydrogen pumping cell in response to the electrical potential measured from the reference cell.

14. The method of claim 12, wherein:
the second reference electrode is in fluid communication with the hydrogen load.

15. A method of operating an integrated electrochemical hydrogen compression system, comprising:
energizing an electrochemical hydrogen pumping cell to flow hydrogen to an inlet of a compressor;
energizing the compressor to flow hydrogen to a hydrogen load;
wherein the compressor has a ratio of (electrical power consumed by the compressor) to (hydrogen flowed to the hydrogen load); and
increasing an electrical potential supplied across the electrochemical hydrogen pumping cell when the ratio falls below a predetermined threshold.

16. The method of claim 15, further comprising:
modulating an electrical potential across the electrochemical hydrogen pumping cell to control a pressure of the hydrogen flowed to the compressor inlet.

17. The method of claim 15, further comprising:
modulating an electrical current fed through the electrochemical hydrogen pumping cell to control a flow rate of the hydrogen flowed to the compressor inlet.

18. The method of claim 15, further comprising:
measuring an electrical potential of a reference cell, wherein the reference cell has a first reference electrode and a second reference electrode, wherein the first reference electrode is in fluid communication with a first electrode of the electrochemical hydrogen pumping cell, and the second reference electrode is in fluid communication with a second electrode of the electrochemical hydrogen pumping cell.

19. The method of claim 18, further comprising:
varying an electrical potential applied to the electrochemical hydrogen pumping cell in response to the electrical potential measured from the reference cell.

20. The method of claim 18, wherein:
the second reference electrode is in fluid communication with the hydrogen load.

21. A method of operating an integrated electrochemical hydrogen compression system, comprising:
energizing an electrochemical hydrogen pumping cell to generate a hydrogen output;
flowing the hydrogen output to a hydrogen load;
measuring a pressure of the hydrogen output;
energizing a compressor when the pressure of the hydrogen output reaches a predetermined threshold;
flowing hydrogen from the compressor to an inlet of the electrochemical hydrogen pumping cell.

22. A method of operating an integrated electrochemical hydrogen compression system, comprising:
energizing a compressor to supply output hydrogen to a hydrogen load;
measuring a pressure of the output hydrogen;
energizing an electrochemical hydrogen pumping cell when the pressure reaches a predetermined threshold;
flowing the output hydrogen to an inlet of the electrochemical hydrogen pumping cell;
exhausting hydrogen from the electrochemical hydrogen pumping cell to the hydrogen load at an elevated pressure.

23. A method of operating an integrated electrochemical hydrogen compression system, comprising:
energizing an electrochemical hydrogen pumping cell to supply hydrogen to a compressor;
energizing the compressor to supply hydrogen to a hydrogen load;
maintaining a differential pressure across the compressor within a predetermined range; and
varying an outlet pressure of the electrochemical hydrogen pumping cell to vary an outlet pressure of the compressor.

24. The method of claim 23, wherein the differential pressure across the compressor is held constant.

25. The method of claim 23, further comprising:
modulating an electrical potential across the electrochemical hydrogen pumping cell to control a pressure of the hydrogen supplied to the compressor.

26. The method of claim 23, further comprising:
modulating an electrical potential across the electrochemical hydrogen pumping cell to hold constant the pressure of the hydrogen supplied to the compressor.

27. The method of claim 23, further comprising:
modulating an electrical current fed through the electrochemical hydrogen pumping cell to control a flow rate of the hydrogen supplied to the compressor.

28. The method of claim 23, further comprising:
measuring an electrical potential of a reference cell, wherein the reference cell has a first reference electrode and a second reference electrode, wherein the first reference electrode is in fluid communication with a first electrode of the electrochemical hydrogen pumping cell, and the second reference electrode is in fluid communication with a second electrode of the electrochemical hydrogen pumping cell.

29. The method of claim 28, further comprising:
varying an electrical potential applied to the electrochemical hydrogen pumping cell in response to the electrical potential measured from the reference cell.

30. The method of claim 28, wherein:
the second reference electrode is in fluid communication with the hydrogen load.

31. A method of operating an integrated electrochemical hydrogen compression system, comprising:
energizing a compressor to supply hydrogen to an electrochemical hydrogen pumping cell;
energizing the electrochemical hydrogen pumping cell to supply hydrogen to a hydrogen load;
maintaining a differential pressure across the compressor within a predetermined range; and
varying an outlet pressure of the electrochemical hydrogen pumping cell.

32. The method of claim 31, wherein the differential pressure across the compressor is held constant.

33. The method of claim 31, further comprising:
modulating an electrical potential across the electrochemical hydrogen pumping cell to control a pressure of the hydrogen supplied to the compressor.

34. The method of claim 31, further comprising:
modulating an electrical potential across the electrochemical hydrogen pumping cell to hold constant the pressure of the hydrogen supplied to the compressor.

35. The method of claim 31, further comprising:
modulating an electrical current fed through the electrochemical hydrogen pumping cell to control a flow rate of the hydrogen supplied to the compressor.

36. The method of claim 31, further comprising:
measuring an electrical potential of a reference cell, wherein the reference cell has a first reference electrode and a second reference electrode, wherein the first reference electrode is in fluid communication with a first electrode of the electrochemical hydrogen pumping cell, and the second reference electrode is in fluid communication with a second electrode of the electrochemical hydrogen pumping cell.

37. The method of claim 36, further comprising:
varying an electrical potential applied to the electrochemical hydrogen pumping cell in response to the electrical potential measured from the reference cell.

38. The method of claim 36, wherein:
the second reference electrode is in fluid communication with the hydrogen load.

39. An integrated electrochemical hydrogen compression system, comprising:
an electrochemical hydrogen pumping cell;
a compressor;
wherein the electrochemical hydrogen pumping cell has an inlet in fluid communication with a hydrogen source;
wherein the electrochemical hydrogen pumping cell has an outlet in fluid communication with a compressor inlet of the compressor; and
wherein the compressor has a compressor outlet in fluid communication with a hydrogen load.

40. The system of claim 39, further comprising:
a valve adapted to regulate hydrogen flow between the electrochemical hydrogen pumping cell and the compressor.

41. The system of claim 39, further comprising:
a heater adapted to heat the electrochemical hydrogen pumping cell.

42. The system of claim 39, further comprising:
a heater adapted to heat hydrogen from the hydrogen source as it is fed to the electrochemical hydrogen pumping cell.

43. The system of claim 39, further comprising:
a bypass line from the electrochemical hydrogen pumping cell outlet to the compressor outlet;
a controller adapted to measure a pressure of the compressor outlet;
wherein the controller is adapted to supply the hydrogen load via the bypass line when the compressor outlet pressure is below a predetermined threshold; and
wherein the controller is adapted to close the bypass line when the compressor outlet pressure is above a predetermined threshold.

44. The system of claim 39, further comprising:
a vessel in fluid communication between the electrochemical hydrogen pumping cell outlet and the compressor inlet.

45. The system of claim 39, wherein the compressor has a ratio of (electrical power consumed by the compressor) to (hydrogen flowed to the hydrogen load), further comprising:
a controller adapted to increase an electrical potential supplied across the electrochemical hydrogen pumping cell when the ratio falls below a predetermined threshold.

46. The system of claim 39, further comprising:
a power supply adapted to vary an electrical potential supplied to the electrochemical hydrogen pumping cell to produce a predetermined outlet pressure of hydrogen at the outlet of the electrochemical hydrogen pumping cell.

47. The system of claim 39, further comprising:
a power supply adapted to vary an electrical current fed through the electrochemical hydrogen pumping cell to produce a predetermined flow of hydrogen at the outlet of the electrochemical hydrogen pumping cell.

48. The system of claim 39, further comprising:
a reference cell, wherein the reference cell has a first reference electrode and a second reference electrode, wherein the first reference electrode is in fluid communication with a first electrode of the electrochemical hydrogen pumping cell, and the second reference electrode is in fluid communication with a second electrode of the electrochemical hydrogen pumping cell.

49. The system of claim 48, further comprising a power supply adapted to vary an electrical potential applied to the electrochemical hydrogen pumping cell in response to an electrical potential of the reference cell.

50. The system of claim 48, wherein the second reference electrode is in fluid communication with the hydrogen load.

51. An integrated electrochemical hydrogen compression system, comprising:
a compressor;
an electrochemical hydrogen pumping cell;
wherein the compressor has a compressor inlet in fluid communication with a hydrogen source;
wherein the compressor has a compressor outlet in fluid communication with an inlet of the electrochemical hydrogen pumping cell; and
wherein the electrochemical hydrogen pumping cell has an outlet in fluid communication with a hydrogen load.

52. The system of claim 51, further comprising:
a valve adapted to regulate hydrogen flow between the electrochemical hydrogen pumping cell and the compressor.

53. The system of claim 51, further comprising:
a heater adapted to heat the electrochemical hydrogen pumping cell.

54. The system of claim 51, further comprising:
a heater adapted to heat hydrogen from the hydrogen source as it is fed to the electrochemical hydrogen pumping cell.

55. The system of claim 51, further comprising:
a bypass line from the compressor outlet to the hydrogen load;
a controller adapted to measure a pressure of the compressor outlet;
wherein the controller is adapted to supply the hydrogen load via the bypass line when the compressor outlet pressure is below a predetermined threshold; and
wherein the controller is adapted to close the bypass line when the compressor outlet pressure is above a predetermined threshold.

56. The system of claim 51, further comprising:
a vessel in fluid communication between the electrochemical hydrogen pumping cell inlet and the compressor outlet.

57. The system of claim 51, wherein the compressor has a ratio of (electrical power consumed by the compressor) to (hydrogen flowed to the hydrogen load), further comprising:
a controller adapted to increase an electrical potential supplied across the electrochemical hydrogen pumping cell when the ratio falls below a predetermined threshold.

58. The system of claim 51, further comprising:
a power supply adapted to vary an electrical potential supplied to the electrochemical hydrogen pumping cell to produce a predetermined outlet pressure of hydrogen at an outlet of the electrochemical hydrogen pumping cell.

59. The system of claim 51, further comprising:
a power supply adapted to vary an electrical current fed through the electrochemical hydrogen pumping cell to produce a predetermined flow of hydrogen at an outlet of the electrochemical hydrogen pumping cell.

60. The system of claim 51, further comprising:
a reference cell, wherein the reference cell has a first reference electrode and a second reference electrode, wherein the first reference electrode is in fluid communication with a first electrode of the electrochemical hydrogen pumping cell, and the second reference electrode is in fluid communication with a second electrode of the electrochemical hydrogen pumping cell.

61. The system of claim 51, further comprising a power supply adapted to vary an electrical potential applied to the electrochemical hydrogen pumping cell in response to an electrical potential of the reference cell.

62. The system of claim 51, wherein the second reference electrode is in fluid communication with the hydrogen load.
